(19) United States
(12) Patent Application Publication
(10) Pub. No.: US 2012/0074210 A1
(43) Pub. Date: Mar. 29, 2012

(54) SOLDERING PREFORM

(75) Inventor: Franc DUGAL, Zollikon (CH)

(73) Assignee: ABB Technology AG, Zurich (CH)

(21) Appl. No.: 13/270,655

(22) Filed: Oct. 11, 2011

Related U.S. Application Data
(63) Continuation of application No. PCT/EP2010/054708, filed on Apr. 9, 2010.

(30) Foreign Application Priority Data
Apr. 9, 2009 (EP) 09157697.5

(51) Int. Cl. B23K 1/20; B23K 35/14

(52) U.S. Cl. 228/214; 228/56.3

(57) ABSTRACT

A soldering preform for soldering in a reducing atmosphere is substantially disc-shaped and has two soldering surfaces each for being in contact with an object to be soldered, respectively, and with at least one recess on at least one soldering surfaces for constituting a channel open to a surface of the object.

### RELATED APPLICATION(S)

This application claims priority as a continuation application under 35 U.S.C. §120 to PCT/EP2010/054708, which was filed as an International Application on Apr. 9, 2010 designating the U.S., and which claims priority to European Application 09157697.5 filed in Europe on Apr. 9, 2009. The entire contents of these applications are hereby incorporated by reference in their entireties.

### FIELD

The disclosure relates to a soldering preform for soldering in a reducing atmosphere and for large area soldering.

### BACKGROUND INFORMATION

Soldering is a technique for connecting two metal elements. The presence of oxide on one or both surfaces of the two elements to be joined can cause voids in the solder after the soldering process. The presence of voids can reduce electrical and thermal conductivity and mechanical strength of the connection. This is also known as a wetting problem. Therefore, the oxide layers can be removed by a cleaning step prior to soldering and by the use of an oxide cleaning flux during soldering integrated in a soldering preform or introduced as a liquid. Components of the flux can remain within and on the solder such that an additional cleaning step after soldering is needed.

European Patent Application EP 0 504 601 A2 discloses a solder joint of pins on a metallized ceramic substrate through solder balls by soldering in a reducing atmosphere. The reducing atmosphere, here hydrogen, can react with oxygen and an oxide layer and thus, clean the soldering areas. Therefore, the use of a liquid flux or a flux integrated in the soldering preform and the residue following from the flux can be avoided. This can reduce the usage of chemical solvents and flux and thus, can reduce cost and environmental burden. This can work well for small area soldering like a pin connection but is not applicable for large area soldering. For large area soldering, large flat soldering preforms can be used. In known preforms, the reducing atmosphere only penetrates the border zone between the soldering element and the soldering preform such that the oxide layer in the centre of the contact area is not removed and voids are created in the solder during soldering.

Some further soldering preforms are known from U.S. Pat. No. 5,242,097 and U.S. Pat. No. 5,820,014. Each of these describe a soldering preform. The described soldering preform is a continuous preform which forms during the soldering process a plurality of solder points which are separated from each other.

### SUMMARY

A soldering apparatus is disclosed for soldering in a reducing atmosphere, comprising a substantially disc-shaped preform having two soldering surfaces each for contacting an object to be soldered, and at least one channel formed into the soldering preform, the at least one channel being open towards at least one of the soldering surfaces and open to a reducing atmosphere when the two soldering surfaces are in contact with objects to be soldered.

A method of soldering is disclosed using a substantially disc-shaped preform, having two soldering surfaces each for contacting an object to be soldered and at least one channel formed into the soldering preform, the at least one channel being open towards at least one of the soldering surfaces and open to a reducing atmosphere when the two soldering surfaces are in contact with objects to be soldered, the method comprising placing the preform at a soldering position between two objects to be soldered, and establishing a reducing atmosphere around a solder joint area by introducing a reducing medium into the at least one channel.

### DETAILED DESCRIPTION OF THE DRAWINGS

Different exemplary embodiments of a soldering preform according to the disclosure will be described by the drawings. The drawings show:

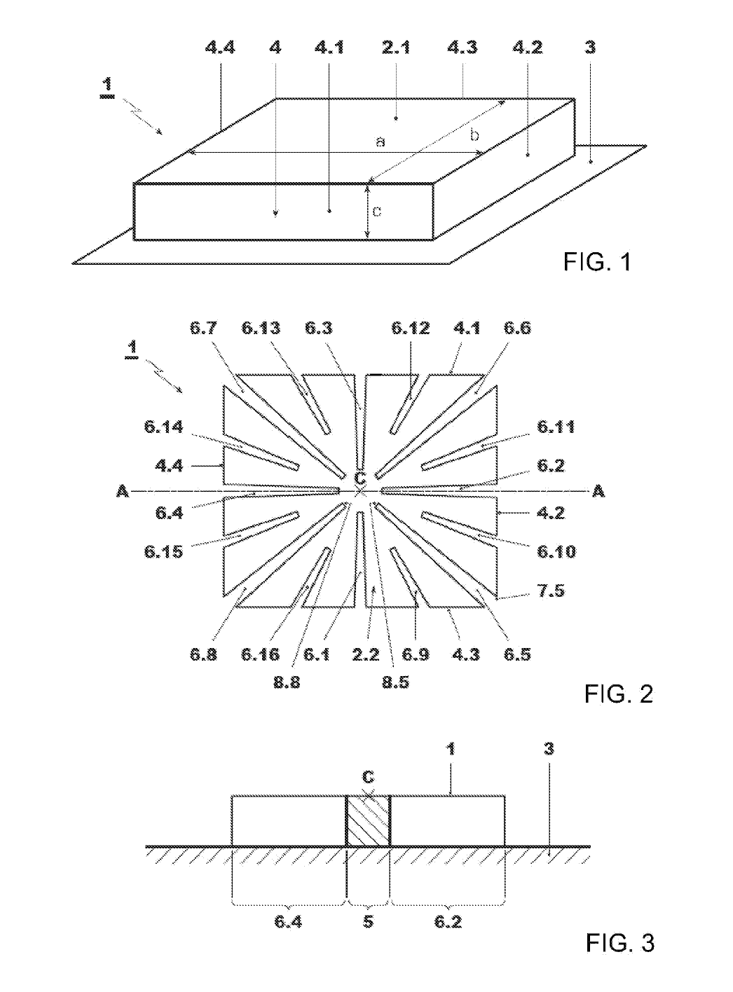

FIG. 1 shows a three-dimensional and schematic view of the original or basic shape of a soldering preform according to the first to fourth exemplary embodiments of the disclosure;

FIG. 2 shows a first view of the soldering surface of the first exemplary embodiment of the soldering preform according to the disclosure;

FIG. 3 shows a cross-sectional view of the first exemplary embodiment of the soldering preform according to the disclosure;

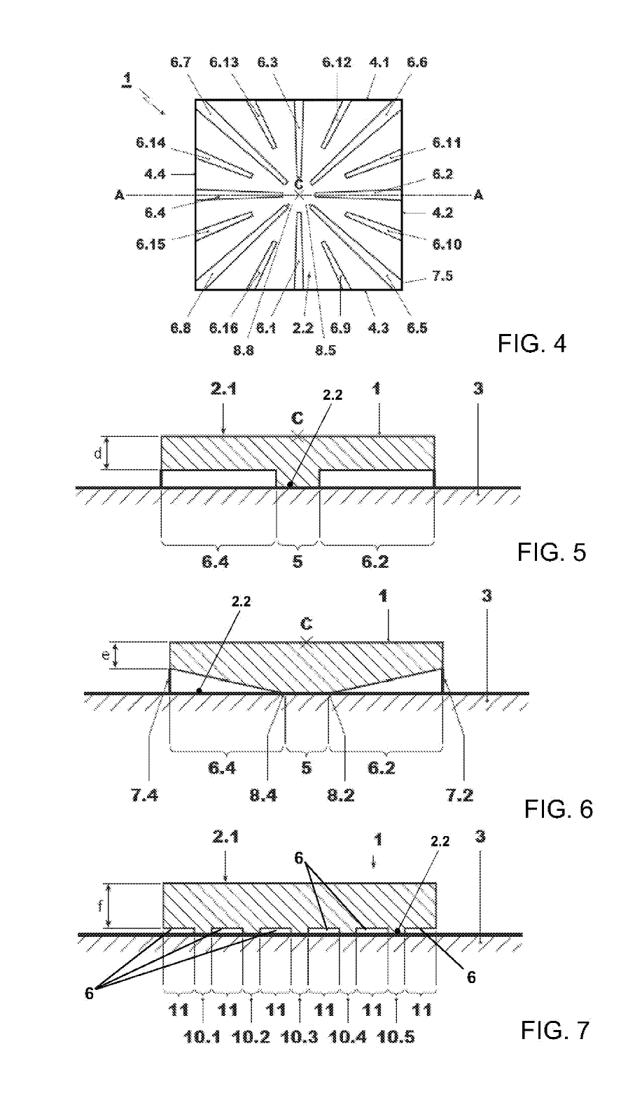

FIG. 4 shows a view of the soldering surface of the second and third exemplary embodiments of the soldering preform according to the disclosure;

FIG. 5 shows a cross-sectional view of the second exemplary embodiment of the soldering preform according to the disclosure;

FIG. 6 shows a cross-sectional view of the third exemplary embodiment of the soldering preform according to the disclosure; and

FIG. 7 shows a cross-sectional view of a fourth exemplary embodiment of the soldering preform according to the disclosure.

### DETAILED DESCRIPTION

The disclosure relates to soldering relatively large areas without voids and without the use of liquid fluxes.

The soldering preform according to an exemplary embodiment of the disclosure enables soldering in a reducing atmosphere and can be shaped like a disc. The soldering preform has two soldering surfaces, each surface for being in contact with an object to be soldered, respectively. On at least one soldering surface, at least one channel is formed which is open to a surface of the object and open to a reducing atmosphere when the two soldering surfaces are in contact with the objects to be soldered.

The soldering preform according to an exemplary embodiment can allow a reducing atmosphere to pass between the object to be soldered and the soldering preform via the channel for the oxide reducing gas and can efficiently remove the oxide layer of the object to be soldered even in its centre region. The oxide reducing gas can also penetrate from the channel between the preform and the object. This can prevent voids between the object to be soldered and the solder and a mechanically stable and electrically and thermically conductive connection can be established without the use of any flux additional to the reducing atmosphere.

It can be desirable to form the at least one channel such that every point of the at least one soldering surface has a longest distance to the channel of the soldering surface smaller than a predetermined distance. If the predetermined distance is well-chosen, the reducing atmosphere can reach each point of the object to be soldered and voids in the solder can be avoided. An exemplary predetermined distance can be, for example, less than about 6 mm but more than about 1 mm.

In an exemplary embodiment according to the disclosure, the at least one channel is open to the outer border of the soldering preform. This can have the advantage that the reducing atmosphere can easily enter the channel.

According to an exemplary embodiment, the at least one channel can be tapered from a maximum opening at the outer border versus the inside of the soldering preform. Therefore, capillary forces close the channel during the melting process of the soldering preform beginning from its inside end to the outer opening with a maximum width at the outer border. Experiments have shown that a maximum opening at the outer border of the soldering preform of, for example, substantially 3 mm is desirable, because the reducing atmosphere can still effectively enter into the channel and the melting solder can close the opening of 3 mm completely without any voids in the solder.

In an exemplary embodiment, the at least one soldering surface can have a plurality of channels. The channels are independent and separated and lead the reducing atmosphere in between the soldering preform and the object to be soldered. If there is only one channel, the channel would have to be formed in a curve, for example, as a spiral, to reach all regions of the contact surface. The curves can hinder the reducing gas to efficiently and quickly flow through the channel. In addition, if this single channel has only one path to the outer border, an early closure of the path would encase the void of the whole channel.

In another exemplary embodiment, each of the plurality of channels can have a longitudinal axis running through the centre point of the soldering surface or of the soldering preform. Thus, each channel can bring the reducing gas quickly and without any drawbacks from the outer border to the centre-region of the soldering surface.

According to the disclosure, each channel can, for example, be separated from other channels. If the channels are formed by cuts through the soldering preform, this feature can prevent the falling apart of the soldering preform. This can lead to an easy to handle one piece preform.

In an exemplary embodiment, the soldering preform can be transected from one soldering surface to the other to form the channels. This can allow producing the soldering preform in a very easy and inexpensive way, for example, by die-cutting the soldering preform or extruding. In addition, the channels can work as an oxide reducing measure on both soldering surfaces of the soldering preform at the same time.

In another exemplary embodiment, a thickness of the soldering preform can be bigger than the final soldering thickness. In this way, the loss of thickness of the solder by filling up the at least one channel with solder can be compensated.

In an exemplary embodiment according to the disclosure a volume of the solder can be chosen in the soldering preform bigger than the final soldering volume. In this way, the loss of volume of the solder by latterly outflow of the solder can be compensated.

FIG. 1 shows a basic shape of a soldering preform 1 being the basis for the exemplary embodiments explained below. FIG. 1 does not show details about the structure of the soldering preform 1 or details of the form, but a rough form of the soldering preform 1. The soldering preform 1 has two parallel soldering surfaces 2.1 and 2.2 whereby the last one of them is not seen in the shown perspective. The soldering surfaces 2.1 and 2.2 are the sides of the soldering preform 1 being in contact with the objects to be soldered or joined to each other, respectively, before and during the soldering process. Here the objects to be soldered are a copper substrate 3 to which a power electronic module with a contact area (not shown in the figures) can be soldered. However, other objects are also possible. In FIGS. 1, 3, 5 to 7, only the substrate 3 is shown. Beside copper substrates also other substrates such as, for example, nickel, silver or gold or alloys thereof, or any other substrate used in semiconductor technology, in particular in power semiconductor technology, can be chosen.

The original or basic shape of the soldering preform 1 is a cuboid with the width a, length b and the thickness c. The thickness c has at least one order, but can be two orders of magnitude less than the width a and length b. In the following exemplary embodiments, the thickness c is 0.3 mm, the width a is 47 mm and the length b is 56 mm without any restriction to the disclosure. Additional to the soldering surfaces 2.1 and 2.2, there is the outer border 4 of the soldering preform 1 including four outer border sides 4.1, 4.2, 4.3 and 4.4 which can be arranged rectangular.

The form shown does not limit the disclosure. The original or basic shape of the soldering preform 1 can have every kind of disc-shape which can be defined as having a thickness smaller than the length and width of the soldering preform. For example, the thickness can be at least one or two orders of magnitude smaller than the length and width of the soldering preform. The soldering surfaces 2.1 and 2.2 can be parallel to each other. Further, the soldering surfaces 2.1 and 2.2 of the original or basic shape can have an arbitrary shape such as a circle, ellipse, triangle, rectangle, other polygons or any further custom forms. The original or basic shape of the soldering preform 1 as well as the soldering preform 1 as described below has however no through hole. The soldering preform 1 is simply connected (in the mathematical sense). The soldering preform is for forming a continuous soldering layer between the objects to be soldered to each other. The soldering preform 1 can be useful for large area soldering of at least 80 mm², for example, at least 120 mm² and at least 1000 mm². These areas are continuous areas. The size and/or shape of the soldering area is at least similar to the ground area of the original or basic shape of the soldering preform. The ground area can be regarded as a first characterizing size. The ground area can have the shape of a rectangle as shown in FIG. 1 to FIG. 7, but other shapes such as a circle or ellipse can be possible.

FIG. 2 shows a top view of the soldering surfaces 2.2 of the soldering preform 1. According to an exemplary embodiment of the disclosure, separated channels 6.1 to 6.16 can be formed in the soldering preform 1. In the embodiment, the channels 6.1 to 6.16 can be formed by removing material from the original shape as shown in FIG. 1. Thus, the channels of the first embodiment are formed by recesses. The channels 6.1 to 6.16 can be cut outs of the soldering preform 1. This can be easy and inexpensive to produce, for example, by blanking. In addition, the structure of the channels 6.1 to 6.16 can apply at the same time to both soldering surfaces 2.1 and 2.2.

As an alternative, channels can also be formed by reducing the thickness of the soldering preform 1 instead of forming cut outs into the soldering preform 1, which will be described with respect to the FIGS. 4 to 7.

The geometry of the recesses forming the channels 6.1 to 6.16 can be chosen such that every point of the soldering surfaces 2.1, 2.2 lays maximally within a predetermined distance from a closest point of the channel 6.1 to 6.16 or of the outer border 4 of the soldering preform 1. In general, when the predetermined distance is chosen as the standard depth of penetration of the reducing atmosphere in between the copper substrate 3 and the soldering surface 2.1, 2.2 of the soldering preform 1, the complete area of the copper substrate 3 covered by the soldering preform 1 can be reached by the reducing atmosphere.

In the exemplary embodiment, this geometry can be realized by N channels 6.i with i=1, 2, 3, . . . , N leading from the outer border 4 of the soldering preform 1 versus the centre point C of the soldering surface 2.2 or of the preform 1. The channels 6.i do not cut each other or do not reach the centre point. Here N=16 channels 6.1 to 6.16 are arranged such that their longitudinal axes run through the centre point C. Each channel 6.i has an opening 7.i to the outer border 4 and a channel end 8.i, which is situated in a finite distance to the centre point C in the direction to the opening 7.i. The reference signs 7.i and 8.i are only representatively shown in FIG. 2 for the channel 6.5, but count for all channels 6.1 to 6.16.

The number N of channels 6.1 to 6.N can be determined by the above given geometry condition with the maximum distance of every point of the soldering surface 2.1, 2.2 to the closest channel 6.i or to the outer border 4 being smaller or equal to the predetermined distance and thus, dependant on the depth of penetration of the reducing atmosphere and the size and form of the soldering surface 2.2. The geometry can be constructed by starting to cut out channels 6.1 to 6.4 each starting with the opening 7.1 to 7.4 from the centre point of the outer border sides 4.3, 4.2, 4.1 and 4.4, respectively, and leading to the centre point C of the soldering surface 2.2. The channel ends 8.1 to 8.4 have a distance to the centre point C of at most the depth of penetration. If there still remains areas in the soldering surfaces 2.1, 2.2 having a closest distance to the outer border 4 or to one of the channels 6.i of the soldering surface larger than the predetermined distance, further channels 6.5 to 6.8 are cut out. The points of such an area will be called in the further ongoing without any restriction to the disclosure white points.

The next channels 6.5 to 6.8 start with the openings 7.5 to 7.8 from the four vertices of the soldering surface 2.2 and lead versus the centre point C. Since the channels 6.1 to 6.4 already cover the centre region with reducing atmosphere during a soldering process, the channels 6.5 to 6.8 do not have to reach as far to the centre point C as the channels 6.1 to 6.4. The four channel ends 8.5 to 8.8 can be chosen such that the distance between the four white points being closest to the centre point C, respectively, are reached by the reducing atmosphere conducted by the channels 6.5 to 6.8, for example, the distance from the respective white point being closest to the centre point C to their closest channel ends 8.5 to 8.8 is smaller than or equal to the predetermined distance.

If there still remain white points between two channels, for example, 6.3 and 6.6, another channel 6.12 is cut out in between the channels 6.3 and 6.6. The opening 7.12 of the channel 6.12 is the middle between the opening 7.3 and the opening 7.6. The channel 6.12 leads versus the centre point C and the channel end 8.12 has a distance of at most the predetermined distance to the white point between the two channels 6.3 and 6.12 being closest to the centre point C. Alternatively, the channels 6.i can lead versus the white point being closest to the centre point C between the two neighbouring channels 6.i instead of to the centre point C. For the channels 6.1 to 6.8, this makes no difference because of the symmetry. Thus, the construction rule for this geometry can be generalized: (1) Cutting out n channels equidistantly or symmetrically arranged on the soldering surface 2.2 from the outer border 4 versus the centre point C with a distance to the centre point C smaller than or equal to the predetermined distance. (2) Finding the white points being closest to the centre point C. (3) Cutting out one new channel for each closest white point found starting from the middle between the two openings of the neighboured channels versus the corresponding white point until the channel end has a distance to the corresponding white point being smaller than the predetermined distance. (4) Repeat step (2) and (3) until all white points vanish.

There are many possible alternative geometries to realize the above mentioned condition. An alternative simple geometry could be to cut out channels from two opposing sides, for example, the outer border sides 4.1 and 4.3, rectangular to the outer border 4 versus a centre line of the soldering surface 4.

The centre line runs through the middle points of the side-lines 4.2 and 4.4 and the centre point C. The opposing channels could be arranged symmetrically to the centre line or with an off-set in the direction to the centre line.

Describing the two-dimensional geometry of the channel or the channels in the top view of the soldering surface 2.2, the outer border sides 4.1 to 4.4 are used without any restriction of the two-dimensional outer border sides 4.1 to 4.4 as outer border lines, because the outer border sides 4.1 to 4.4 are rectangular to the soldering surface 2.2 and thus, their projection on the soldering surface 2.2 are lines.

The opening 7.i of a channel can be wider than the channel end 8.i, for example, the width of the channels 6.1 to 6.16 in the layer of the soldering surface 2.2 tapers versus the centre point C. The width of a channel 6.i can be defined as the distance between the side-walls of the channel 6.i measured perpendicular to the longitudinal axis of the channel 6.i. For example, the width of the channels 6.1 to 6.16 can be, for example, 1 mm at their channel ends 8.1 to 8.16 and 3 mm at their openings 7.1 to 7.16. The width of the channels 6.1. to 6.16 can be, for example, between 1 mm and 5 mm, for example, between 2 mm and 4 mm, and, for example, between 2.5 mm and 3.5 mm at their openings 7.1 to 7.16. Further, the openings 7.i of the channels can be separated from each other by at least the width of the channels. The choice of the widths can depend on the soldering-conditions, such as solder-material and the soldering process itself. The tapered channels 6.1 to 6.16 can have an advantage that during soldering, when the solder melts, the solder closes the channels 6.1 to 6.16 starting from the narrower channel ends 8.1 to 8.16 to the broadened openings 7.1 to 7.16. This is caused by capillary forces. Thus, the enclosure of voids by closing a channel 6.i starting from the opening 7.i or somewhere between the channel end 8.i and the opening 7.i can be avoided. In addition, the tapering of the channels 6.1 to 6.16 considers that through the openings 7.1 to 7.16 a larger amount of reducing atmosphere has to be transported than at the channel ends 8.1 to 8.16.

The ratio of the total volume of the channels to the volume of the solder material of the soldering preform can, for example, be specified to be at most 1:1, for example, at most 1:1.2 or at most 1:1.5.

FIG. 3 shows the cross-sectional view A-A of the soldering preform 1 as shown in FIG. 2. The cross-sectional view of the soldering preform 1 cuts the solid part of the soldering preform 1 in a central region 5 of the soldering preform 1 through the centre point C. The cross-sectional view leads as well through the channels 6.2 and 6.4.

In the following, further embodiments of the disclosure are described. Only the differences will be described in detail. In the figures as well as in the following description, the same reference numerals and terms are used for same or similar terms of the different embodiments.

A second and a third exemplary embodiment of the disclosure can have the same general shape of the soldering preform 1 as shown in FIG. 1 and basically the same geometry of the channels as shown in FIG. 2 and as described in the first embodiment of the disclosure. FIG. 4 shows a cross-sectional view A-A of FIG. 4 for the second embodiment of the disclosure. Instead of channels 6.1 to 6.16 constituted over the entire thickness as in the first embodiment (see FIG. 2, 3), in the second embodiment, the channels 6.1 to 6.16 can be formed by grooves. In a region adjacent to the grooves forming the channels 6.1 to 6.16 and perpendicular to the soldering surfaces 2.1, 2.2, the soldering preform 1 according to the second embodiment of the disclosure can have a finite thickness d smaller than the thickness c in the region of the soldering preform adjacent and perpendicular to the soldering surface 2.2, which is in FIG. 5 the central region 5.

FIG. 6 shows a cross-sectional view A-A of FIG. 4 for the third embodiment of the disclosure. The soldering preform 1 has tapered grooves forming the channels 6.1 to 6.16. The channels 6.1 to 6.16 taper additionally or alternatively to the tapering in the direction of the width of the grooves 6.1 to 6.16 as described with respect to the first embodiment in the direction of the depth of the grooves 6.1″ to 6.16″. The direction of the depth is parallel to the direction of the thickness of the soldering preform 1. Similarly, to the first and second embodiments of the disclosure, the depth of the channels 6.1 to 6.16 can taper from the opening 7.1 to 7.16 to the channel ends 8.1 to 8.16, respectively. Thus, the thickness of the soldering preform 1 along each channel 6.i continuously increases from the thickness e at the opening 7.i to the thickness c at the channel end 8.i. The advantages of the tapering of the width of the channels 6.1 to 6.16 apply accordingly here.

A fourth exemplary embodiment of the disclosure is described in the following. FIG. 7 shows the soldering preform 1 according to the fourth embodiment of the disclosure. An exemplary form of the soldering preform 1 can be similar to the one described for the first embodiment in FIG. 1 and therefore, the reference signs of FIG. 1 for the sides apply even to the soldering preform 1. A first region 10 and a second region 11 are formed on one side of the soldering preform 1. The first region 10 divides into separated dips 10.1 to 10.5 as sub-regions protruding the second region 11. Thus, the soldering preform 1 lays with the dips 10.1 to 10.5 as the soldering surface 2.2 on the copper substrate 3 before and during soldering. The cross-sectional view shows only the dips 10.1 to 10.5. Further dips can be arranged in a row behind and before the dips 10.1 to 10.5.

This can be possible, if the second region 11 has a finite thickness f. If the second region 11 would be cut out and the first region 10 is not connected, the soldering preform 1 can fall apart. The thickness f of the second region 11 can be smaller than the thickness c of the first region 10. Between the dips 10.1 to 10.5 channels 6 can be formed. Consequently, the channels according to the fourth embodiment can run in parallel and/or perpendicular to each other. Alternatively to dips 10.1 to 10.5, even continuous banks can be used such that the second region 10 would as well be split up into sub-regions.

Similar to the first and second embodiment, the width and/or thickness of the channels of the fourth embodiment can be tapered. The tapering is from the outer border 4 of the soldering preform towards the centre of the soldering preform 1. As each channel is leading from the border 4.1 to the border 4.3 or from the border 4.2 to the border 4.4, each channel is first tapering from the border 4.1 or 4.2 towards the centre of the channel, and from the centre of the channel towards the other border 4.3 4.4 each channel widens.

In the following, the soldering process is described on the basis of the first embodiment of the disclosure. For soldering, the soldering preform 1 is placed at the soldering-position between two objects to be joined such as the copper substrate 3 and a power electronic module not shown in the figures. The arrangement of the copper substrate 3, the soldering preform 1 and the power electronic module is placed in an soldering environment able to heat up the copper substrate 3, the power electronic module and the soldering preform 1 at their contact region. The environment is able to establish a reducing atmosphere such as formic acid gas around the solder joint area. The formic acid gas being around the soldering preform 1 enters via the openings 7.1 to 7.16 into the channels 6.1 to 6.16 until the channel ends 8.1 to 16. The formic acid gas enters over the border of the channels 6.1 to 6.16 and over the outer border 4 between the objects to be soldered and the soldering surfaces 2.1 and 2.2 of the soldering preform 1, respectively, up to a certain depth of penetration depending on the soldering conditions. Since the geometry of the channels is chosen such that every point of the soldering surfaces 2.1., 2.2 has a closest distance to the outer border 4 or at least one of the channels 6.1 to 6.16 smaller than the depth of penetration, the formic acid gas reaches the complete contact area of the power electronic module and of the copper substrate 3. Thus, the oxide layers of the power electronic module and the copper substrate 3 can successfully be removed from the contact surfaces and voids in the solder joint can effectively be avoided during soldering.

After this cleaning step, the contact region of the power electronic module, of the soldering preform 1 and of the copper substrate 3 is heated up to a soldering temperature and the solder of the soldering preform 1 starts to melt. Thanks to the tapered channels 6.1 to 6.16 and/or to the capillary forces, the channels 6.1 to 6.16 close starting from the narrow channel ends 8.1 to 8.16 up to the openings 7.1 to 7.16. Thus, there do not remain any voids in the solder joint. After a cooling down process, a mechanically stable and electrically and thermally conductive connection is produced between the copper substrate 3 and the power electronic module by the soldering preform 1 according to the disclosure.

Accordingly, the reducing gas passes the channels 6.1 to 6.16 in the second and third embodiments of the disclosure or the second region of the soldering preform 1 in the fourth embodiment of the disclosure to remove the oxide layers from the contact surface of the copper substrate.

If a predetermined soldering-distance is desired between the power electronic module and the substrate 3 after the solder process, the thickness c of the soldering preform 1 is chosen slightly bigger than the desired predetermined soldering-distance. The volume of the solder in the soldering preform 1 is chosen such that it corresponds to the volume of the solder joint after soldering with the thickness corresponding to the distance and the area a*b. The thickness c of the soldering preform 1 is chosen such that the soldering preform 1 has the same volume as needed to fill the area of the solder joint a*b with solder to the desired thickness. It can be further considered that some of the solder is normally pressed out of the solder joint and the volume of the solder of the soldering preform 1 is chosen even slightly bigger than the desired volume.

The description has been focused upon the form and geometry of the second region 10 or the channels 6.1 to 6.16 or 6.1 to 6.16 on the soldering surface 2.2 for the second and third embodiment. For the first embodiment of the disclosure, where the channels 6.1 to 6.16 are cut out, the channels 6.1 to 6.16 on the soldering surface 2.1 are similar to the ones on the soldering surface 2.2. For the remaining embodiments, the form and geometry of the channels 6.1 to 6.16 or 6.1 to 6.16 or the second region 11 can be applied symmetrically to the centre layer of the soldering preform to the soldering surface 2.1. The centre layer is the layer in the middle between the parallel soldering surfaces 2.1 and 2.2. If a high quality connection is needed only on one soldering surface of the soldering preform, a second region 11 or the channels 6.1 to 6.16 or 6.1 to 6.16 of the second or third embodiment can be applied only on one of the two soldering surfaces 2.1 and 2.2. The second regions 11 and/or the channels 6.1 to 6.16 or 6.1 to 6.16 for the second and third embodiment on both soldering surfaces 2.1 and 2.2 can even individually be adapted to the objects to be soldered to.

The soldering preform 1 is not restricted to any special objects to be soldered. The soldering preform 1 is applicable for all large area solder joints, in particular for forming solder joints of, for example, at least 80 mm², preferably, for example, of at least 120 mm² and, for example, most preferably of at least 1000 mm².

The disclosure is not restricted to the described embodiments. The features of the described embodiments can be combined in each advantageous way.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A soldering apparatus for soldering in a reducing atmosphere, comprising:
a substantially disc-shaped preform having two soldering surfaces each for contacting an object to be soldered; and
at least one channel formed into the soldering preform, the at least one channel being open towards at least one of the soldering surfaces and open to a reducing atmosphere when the two soldering surfaces are in contact with objects to be soldered.

2. The soldering preform according to claim 1, wherein the soldering preform has no through-hole.

3. The soldering preform according to claim 1, wherein the soldering preform is connected via a simple connector.

4. The soldering preform according to claim 1, wherein the at least one channel comprises:
a geometry on at least one of the soldering surfaces with a longest distance of every point of the soldering surface to a border of the channel being smaller than a predetermined distance, which is defined by a standard depth of penetration of the reducing atmosphere.

5. The soldering preform according to claim 4, wherein the predetermined distance is less than 6 mm.

6. The soldering preform according to claim 1, wherein the at least one channel is open to an outer border of the disc-shaped soldering preform.

7. The soldering preform according to claim 6, wherein the at least one channel tapers from a maximum opening at the outer border.

8. The soldering preform according to claim 7, wherein the maximum opening at the outer border is between 1 mm and 5 mm.

9. The soldering preform according to claim 1, wherein the soldering preform comprises:
a plurality of channels.

10. The soldering preform according to claim 9, wherein each channel has a longitudinal axis running through a centre point of the soldering surfaces or of the soldering preform.

11. The soldering preform according to claim 9, wherein each channel is separated from the other channels.

12. The soldering preform according to claim 1, wherein the at least one channel is a cut-out portion extending from one soldering surface to another soldering surface.

13. The soldering preform according to claim 1, wherein the soldering preform has a plurality of channels running in parallel and/or perpendicular to each other.

14. The soldering preform according to claim 1, wherein a thickness of the soldering preform is larger than a final soldering thickness.

15. The soldering preform according to claim 1, wherein a volume of the soldering preform is larger than a final soldering volume.

16. The soldering preform according to claim 1, wherein a ratio of the total volume of the at least one channel to a volume of a solder material of the soldering preform is at most 1:1.

17. The soldering preform according to claim 1, wherein the soldering preform is selected for forming a continuous soldering layer of at least 80 mm².

18. The soldering preform according to claim 7, wherein the maximum opening at the outer border is between 2 mm and 4 mm.

19. The soldering preform according to claim 7, wherein the maximum opening at the outer border is between 2.5 mm and 3.5 mm.

20. The soldering preform according to claim 1, wherein a ratio of a total volume of the at least one channel to the volume of solder material of the soldering preform is at most 1:1.2.

21. The soldering preform according to claim 1, wherein a ratio of a total volume of the at least one channel to a volume of the solder material of the soldering preform is at most 1:1.3.

22. A method of soldering using a substantially disc-shaped preform, having two soldering surfaces each for contacting an object to be soldered, and at least one channel formed into the soldering preform, the at least one channel being open towards at least one of the soldering surfaces and open to a reducing atmosphere when the two soldering surfaces are in contact with objects to be soldered, the method comprising:
placing the preform at a soldering position between two objects to be soldered; and
establishing a reducing atmosphere around a solder joint area by introducing a reducing medium into the at least one channel.
